(19) United States
(12) Patent Application Publication
(10) Pub. No.: US 2009/0039065 A1
(43) Pub. Date: Feb. 12, 2009

(54) Welding wire and welding method

(76) Inventors: Terumi Nakamura, Ibaraki (JP); Kazuo Hiraoka, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 11/921,793

(22) PCT Filed: Jun. 9, 2006
(86) PCT No.: PCT/JP2006/311649

§ 371 Date: Feb. 29, 2008

(30) Foreign Application Priority Data
Jun. 10, 2005 (JP) 2005-171434

(51) Int. Cl. B23K 9/00; B23K 35/22

(52) U.S. Cl. 219/137 R; 219/146.22

(57) ABSTRACT

A plurality of metal materials to be a composition, without containing a flux, of a required welded portion are laminated in order to improve characteristics such as toughness of the welded portion and to carry out a stable welding operation. A welding wire enclosing an alkaline metal compound is used between the layers. The welding is carried out in a high-purity inert gas atmosphere.

### TECHNICAL FIELD

The present invention relates to a welding wire and welding method.

### BACKGROUND ART

Safety is strongly required regarding the welded portions of structures using high grade steels such as 9% Ni steel and stainless steel intended for low temperature or intended for atomic energy, chemical plants, etc., and it is essential to form defect-free welded metals with excellent toughness and ductility. In order to obtain high quality welded joints in such structures, welding in an inert gas (argon, helium or a mixture gas thereof) atmosphere is indispensable. When welding in an inert gas atmosphere, only non-consumable electrode tungsten inert gas (TIG) arc welding of low production efficiency is available presently. TIG welding has been carried out for as long as 30 or more years at the expense of productivity.

On the other hand, although arc welding of excellent production efficiency such as consumable electrode (welding wire) MIG or MAG arc welding has been employed widely in a production site, it is considered impossible to apply this welding method to an inert gas atmosphere. The reason is that the concentration point (cathode spot) of a local arc current formed in the surface oxide of a material to be welded (base material) moves around randomly and violently in search of an oxide, and the arc becomes unstable leading to the generation of welding defects such as meandering beads, blow holes and undercuts, thereby not forming a good welded portion.

In MIG arc welding, in order to solve the instability of the arc in the case where the welding is carried out in an inert gas atmosphere, it is proposed to add roughly 0.5 to 5% of an active gas such as oxygen gas or carbon dioxide gas to an inert gas atmosphere (shield gas) and form an oxide on the weld metal (weld pool) surface to restrain the behavior of the cathode spot. However, although the addition of an active gas certainly is effective in stabilizing on the arc, 200 ppm or more of oxygen is contained in a weld metal, and thus poses a problem in that the formation of fine oxide inclusions lowers the ductility and toughness of the welded metal site.

Therefore, a welding method in an inert gas atmosphere that can achieve both high productivity and high quality at the same time is desirable.

### DISCLOSURE OF THE INVENTION

### Problems to be Solved by the Invention

The welding wires used for welding are roughly classified into two categories. One is a solid wire produced by melting metal of the required composition and then drawing it; the other is a metal cored wire produced by adding a metal powder into a flux cored wire or flux made by enclosing a flux with a material called a hoop (Non-Patent Document 1 and Patent Document 1).

For solid wires, homogeneous wires are usually produced. However, cracks may be generated in the processing step to a wire, the yield of a wire is small, or the production of a wire is absolutely difficult.

The production of a flux cored wire or metal cored wire normally accompanies the use of a flux together for improvement of welding performability, and in particular an oxygen-containing flux is used. Because of this, the amount of oxygen is increased in the welded metal, and toughness cannot be ensured. Additionally, the flux has hygroscopicity, and therefore hydrogen is permeable to the welded metal; as a result, cracks at low temperature may be possibly generated. Accordingly, although a flux is effective for improvement of welding performability, it is likely to cause a problem in performance of welded metal sites.

On the other hand, it is proposed that alkaline metal compounds are effective for stabilization of the arc (Patent Documents 2 to 6). However, even in any of the proposals, because an alkaline metal compound is stuck or applied to the surface of a solid wire, it is difficult to quantitatively control the alkaline metal compound at the time of sticking/application, and additionally there is a problem in that the alkaline metal compound is peeled off by handling during welding. It is difficult to appropriately control the amount of an alkaline metal compound required for the stabilization of the arc.
Non-Patent Document 1: Practices of Flux-Containing Wires, edited by Welding Consumable Division, The Japan Welding Engineering Society; Sanpo Publications, Incorporated; First Edition, April, 1994; pp. 23-49.
Patent Document 1: Japanese Patent Application Laid-Open No. 5-10428
Patent Document 2: Japanese Patent Application Laid-Open No. 58-3797
Patent Document 3: Japanese Published Examined Application No. 3-77035
Patent Document 4: Japanese Patent Application Laid-Open No. 8-90275
Patent Document 5: Japanese Published Examined Application No. 2556847
Patent Document 6: Japanese Patent Application Laid-Open No. 2003-290927

The present invention has been made in consideration of the above issues, and an object of the present invention is to provide a welding wire capable of stable welding in an inert gas atmosphere, of readily being made into wire, and of properly being controlled in an amount of an alkaline metal compound, and a method of stable welding in an inert gas atmosphere by use of this welding wire.

### Means for Solving the Problems

As a wire that solves the above problems, the welding wire of the present invention has the following characteristics.

First, a plurality of metal materials are laminated so as to become a required composition without containing a flux, and an alkaline metal compound is enclosed between the layers.

Second, in the above, the alkaline metal compound is a potassium metal compound.

Third, in the above, a rare earth metal compound is mixed into a metal material or potassium metal compound.

Fourth, in the above, the metal materials are different kinds of material.

The welding method of the present invention is a welding method using the welding wire having characteristics of any of the first to forth above, and has the following characteristics.

The welding method involves welding in an inert gas atmosphere containing an inert gas.

In the above, the concentration of the inert gas in the inert gas atmosphere is controlled to be above 95%.

### Effect of the Invention

The behavior of the arc is stabilized during welding and welding ease and efficiency is improved. Additionally, the oxygen content in the welded metal is reduced to a level equivalent to the level of the TIG welding in which the highest quality welded joint is obtained in the existing welding methods.

Furthermore, it becomes possible to make a wire from a material that is difficult to process and that posed difficulties in making it into a wire in a solid wire requiring a homogeneous composition, and it is also expected to readily control the suppliability of a solid wire conventionally which was difficult to be supplied.

### BRIEF DESCRIPTION OF DRAWINGS

FIG. 1 is a sectional view showing an overview of a welding wire of the present invention;

FIG. 2 is a sectional view showing the welding wire of Test Example 1;

FIG. 3 is a sectional view showing the welding wire of Test Example 2;

FIG. 4 is a sectional view showing the welding wire of Test Example 2;

FIGS. 5(a) and 5(b) are diagrams schematically showing behaviors of arcs, respectively, when a potassium metal compound is not applied between layers and when it is applied;

FIG. 6 shows photographs showing behaviors of arcs corresponding to FIGS. 5(a) and 5(b);

FIG. 7 is a diagram showing the relationship between the oxygen content and toughness of welded sites for comparison;

FIGS. 8(a) and 8(b) show photographs of welded sites when a potassium metal compound is not applied between layers and when applied, respectively;

FIG. 9 is a diagram schematically showing the welding wire of Example 2 and a state during arc welding; and

FIGS. 10(a) and 10(b) show, respectively, a photograph of an arc state of Example 2 during welding and a photograph of a welded site.

### BEST MODE FOR CARRYING OUT THE INVENTION

A welding wire of the present invention belongs to a solid wire not containing a flux at all, or a cored wire, made from a metal powder only, not containing a flux at all, and is a novel one not conventionally known.

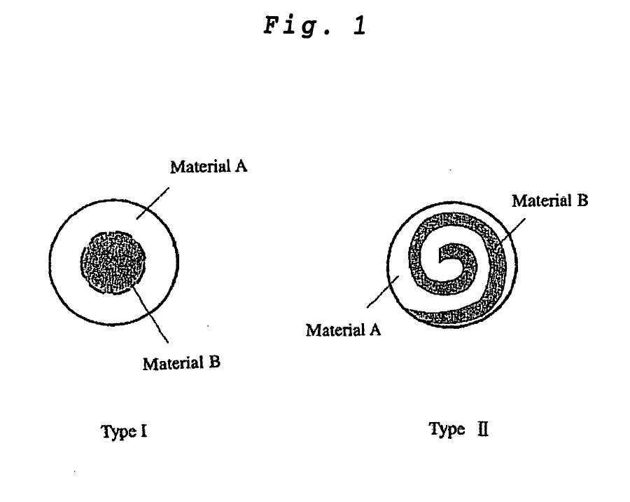

For a welding wire of the present invention, for example, a composition to be required is divided into a plurality of matters, and individual metal materials of a plurality of compositions having good processability, compositions excellent in wire feedability properties, and the like are laminated to be wire processed as shown in FIG. 1. The cross section of the wire can be also an involution type like type II in addition to a coax of type I. When a composition of specific proportions per unit length (calculated from density×area) is met, the required composition is divided into a plurality of matters. Where the individual metal materials are laminated, the materials are made to be a melt alloy in a droplet or molten pool during welding to obtain a necessary metal composition.

The solid wire is produced, as described above, by melting and then drawing. At this time, alkaline metal compounds are generally difficult to melt and cannot also be melted homogeneously. Because of this, an alkaline metal compound cannot be effectively mixed into a welding wire for use.

In a welding wire of the present invention, a required alkaline metal compound is contained in between the layers of a laminate material by means of coating, encapsulation, or the like, to capture a component which cannot be melted, and the property of the component is made exhibited during arc welding. In this case, a plurality of laminate materials are not necessarily different materials and materials having the same composition can also be employed.

The examples of alkaline metal compounds of the present invention include oxides and hydroxides containing at least one species of the alkaline metal elements selected from lithium, potassium, sodium and the like, halogenated substances such as chlorides and iodides, inorganic acid salts of carbonic acid, bicarbonic acid, phosphoric acid, sulfuric acid, nitric acid, perchloric acid, pyrophosphoric acid, and the like, and organic acid salts of acetic acid, phthalic acid, terephthalic acid, stearic acid, oleic acid, and the like. A variety of alkaline metal compounds can be adopted so long as they do not deteriorate the properties of welded sites. Of these, examples of preferred alkaline metal compounds exhibiting excellent effects include single compounds of potassium metal compounds alone or in its mixture with other alkaline metal compounds.

Although the range in which alkaline metal compounds enclosed in a welding wire show excellent effects varies depending on the kind of alkaline metal compounds, it is from 0.1 to 1000 ppm, preferably from 0.5 to 300 ppm, based on the weight of the welding wire.

Although the alkaline metal compound can be enclosed in the form of a fine powder, it can also be dissolved or dispersed in an appropriate solvent and applied for encapsulation. For instance, a high concentrated aqueous solution of an alkaline metal compound using a silicate salt generally called water glass (potassium silicate, sodium silicate, lithium silicate, a mixture thereof, or the like) is applied between the layers of a laminate material and the compound can be enclosed in a welding wire. Water glass is a high-viscosity, liquid-like starch syrup and is a compound readily used at the time of fabrication/processing of a welding wire of the present invention.

The use of a welding wire of the present invention renders it possible to stably and rapidly carry out welding in an inert gas atmosphere, which has conventionally been thought to be extremely difficult to carry out without simultaneous use of a flux or addition of an active gas.

The inert gases that can be used include, for example, argon, helium and mixture gases thereof. In addition, if the concentration of an inert gas in an inert gas atmosphere is controlled to be above 95%, and more preferably 99.5% or more, the mixing of oxygen into welded metal sites is constrained and welding with no defects and excellent toughness and ductility can be carried out.

Additionally, although depending on welding conditions, the use of a welding wire of the present invention and the control of the concentration of an inert gas in an inert gas atmosphere make it possible to control the oxygen content in the welded metal to be 100 ppm or less.

### Test Example 1

For the fabrication of a wire of 11Cr-9.5Ni-based low transformation temperature welding material, an alloy of its composition is normally melted and drawing processing is carried out. Its raw material often generates cracks in the step of drawing and the yield is about 50%.

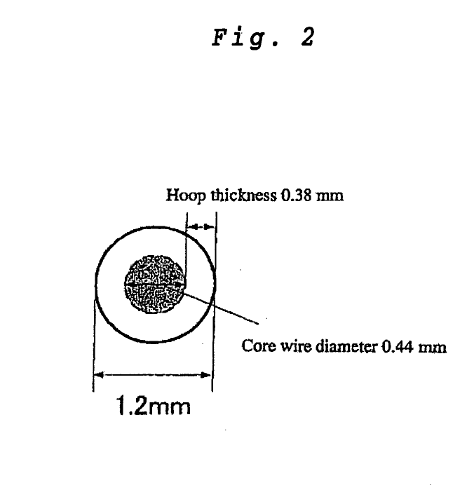

Then, a welding wire was fabricated by using and combining metal materials having two kinds of compositions shown in FIG. 2 and Table 1.

TABLE 1

| | | C | Ni | Cr | Si | Mn |
|---|---|---|---|---|---|---|
| Hoop | For curing | 0.1 | 0 | 10 | 0.8 | 1.6 |
| | build up | | | | | |
| Core wire material | Inconel | 0.03 | 73.94 | 18.38 | 0.19 | 2.99 |
| Target alloy material | 11Cr—9.5Ni | 0.09 | 9.24 | 11.05 | 0.72 | 1.77 |
| | material | | | | | |

A welding wire having a diameter of 1.2 mm, the composition of which corresponds to that of an 11Cr-9.5Ni-based low transformation temperature welding material could be fabricated by using and combining a hoop having a plate thickness of 0.38 mm and a core wire having a diameter of 0.44 mm. Both the hoop and core wire were good in processability, cracks were not generated in the step of drawing, and the yield was greatly improved.

### Test Example 2

In consumable electrode welding, good welding cannot be carried out unless a welding wire is stably supplied during welding. If the welding wire is too rigid, the feed resistance becomes large. In addition, where the welding wire is extremely rigid as compared with the contact tip, the wear of the contact tip is increased, so that clogging or the like is generated and it becomes difficult to carry out good welding. A low transformation temperature welding material is a high strength material having a strength of 1000 MPa or more and has a problem in welding wire feeding. However, the welding wire of Test Example 1 has a strength of 600 MPa or less, and is thought to be improved in feedability properties.

This test example then used a high strength welding material having a strength of about 780 MPa.

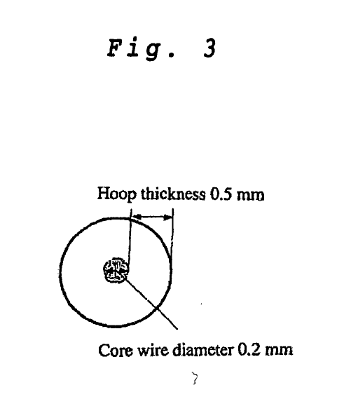

The combination of a hoop having a wire component for SM490 and a diameter of 0.5 mm and a core wire of inconel having a diameter of 0.2 mm, shown in FIG. 3 and Table 2, made it possible to fabricate a welding wire, the composition of which corresponds to that of a welding material for HT780.

TABLE 2

| | | C | Ni | Cr | Si | Mn |
|---|---|---|---|---|---|---|
| Hoop | For SM490 | 0.09 | 0 | 0 | 0.4 | 1 |
| Core wire material | Inconel | 0.005 | 78 | 16 | 0 | 0.03 |
| Target alloy material | For HT780 | 0.09 | 2.34 | 0.48 | 0.39 | 0.97 |

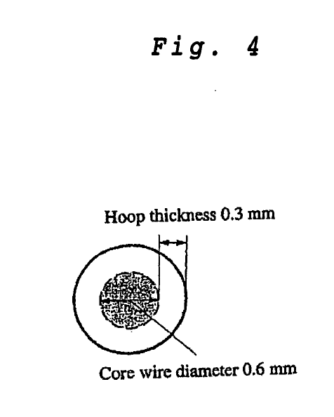

The core wire and hoop are not necessarily commercially available materials. As shown in FIG. 4 and Table 3, a hoop and core wire can be designed in such a manner that the composition becomes a welding wire corresponding to that of a welding material for HT780.

This welding wire had a hardness equivalent to that of a welding material for SM490 and was a welding wire posing no problems in feedability properties, wear of the contact tip, etc. The core wire diameter is 0.6 mm. The above welding wire can have a thick core wire and in fabrication of a welding wire is superior when compared to the welding wire indicated in FIG. 3.

TABLE 3

| | | C | Ni | Cr | Si | Mn |
|---|---|---|---|---|---|---|
| Hoop | Material A | 0.09 | 0 | 0 | 0.4 | 0.4 |
| Core wire material | Material B | 0.05 | 11.1 | 2.13 | 0 | 0.01 |
| Target alloy material | For HT780 | 0.08 | 2.61 | 0.50 | 0.31 | 0.31 |
| | For HT780 | 0.08 | 2.6 | 0.5 | 0.31 | 0.31 |

### EXAMPLES

### Example 1

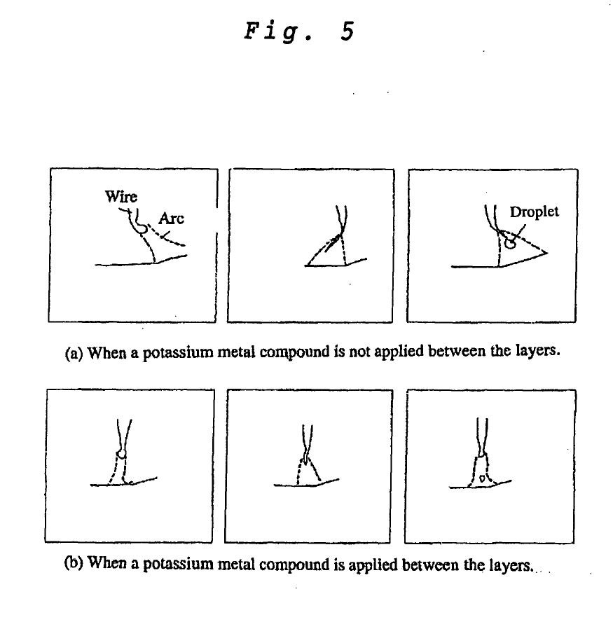

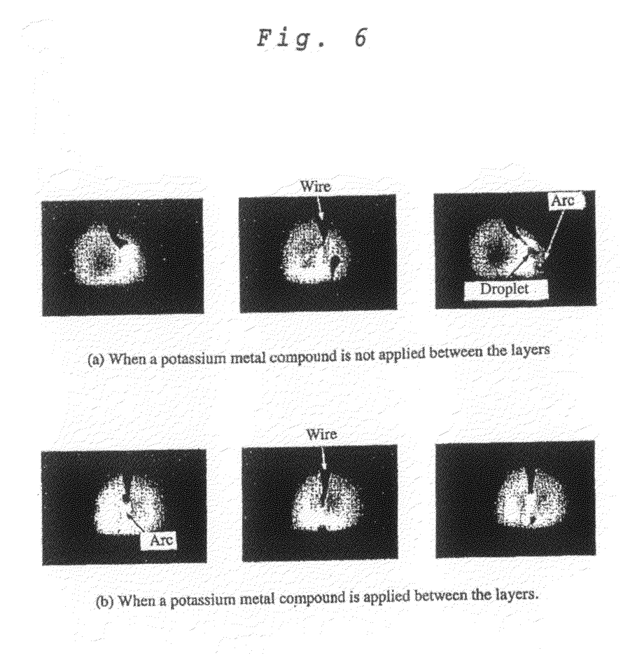

Potassium silicate water glass (chemical composition: about 25 wt % SiO₂, about 15 wt % K₂O, about 1 wt % Na₂O, and the balance being water) as a potassium metal compound was applied between the layers of laminate materials in the welding wires shown in the Test Examples 1 to 3. Because the potassium metal compound was enclosed in the inside of the welding wire, the application state was stable without peeling during welding wire feeding. This welding wire was made a cathode and arc welding was conducted in a pure argon gas atmosphere. FIG. 5(a) shows the case where the potassium metal compound was not applied between the layers; FIG. 5(b) shows the case where the potassium metal compound was applied between the layers. The interlayer application of the potassium metal compound suppressed the spread of arc in the welding edge (anode area) of the welding wire. In FIG. 6, photographs corresponding to those in FIG. 5 were shown.

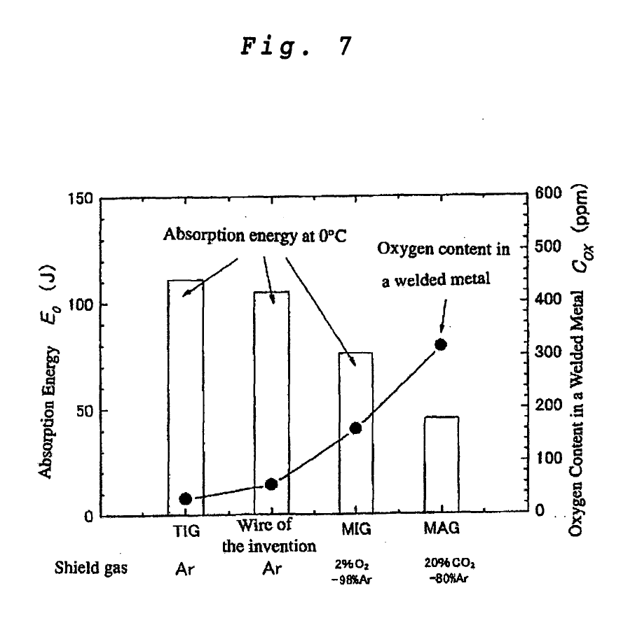

The oxygen content in a welded metal and the toughness after welding produced by welding using a welding wire in which a potassium metal compound was enclosed between the layers was determined. As shown in FIG. 7, the oxygen content is 56 ppm, and an absorption energy value of 105 J at 0° C. indicating toughness is obtained. It is confirmed that excellent welding substantially equivalent to the TIG welding was carried out.

FIG. 7 shows as reference examples measurements of the oxygen contents in welded metals and the toughness by means of the MIG welding using 98% Ar-2% O₂ gas and the MAG welding using 80% Ar-20% CO₂ gas, along with the TIG welding using pure argon. The measurements of the oxygen content in welded metals and the toughness by means of the MIG welding and the MAG welding of the same consumable electrode (welding wire) type as the welding method of the present invention are far inferior to the results of the welding method of the present invention.

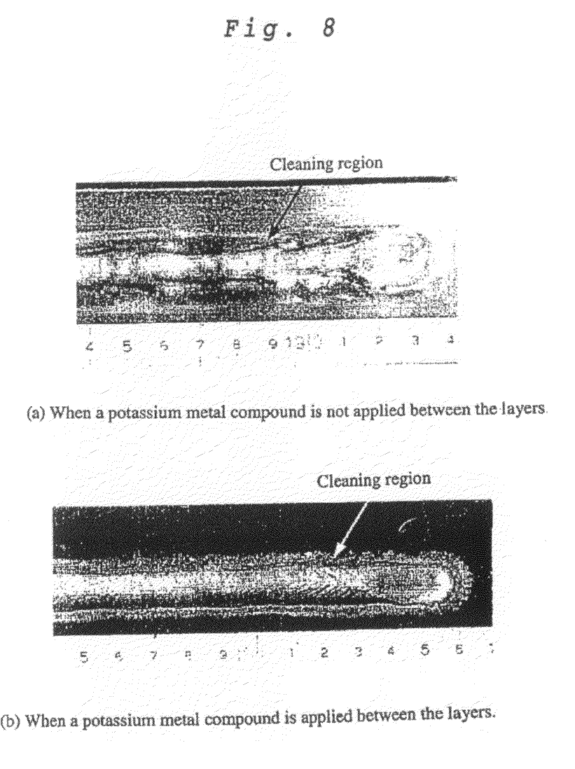

FIG. 8 shows photographs of welded sites after arc welding. Unless a potassium metal compound is applied between the layers, an unstable bead was formed due to the arc becoming unstable. On the other hand, application of a potassium metal compound between the layers made the arc stable, and a linear bead was obtained.

### Example 2

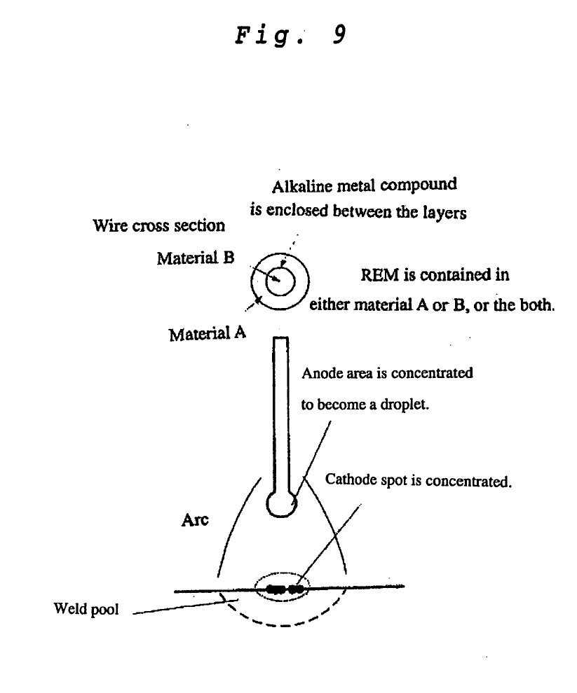

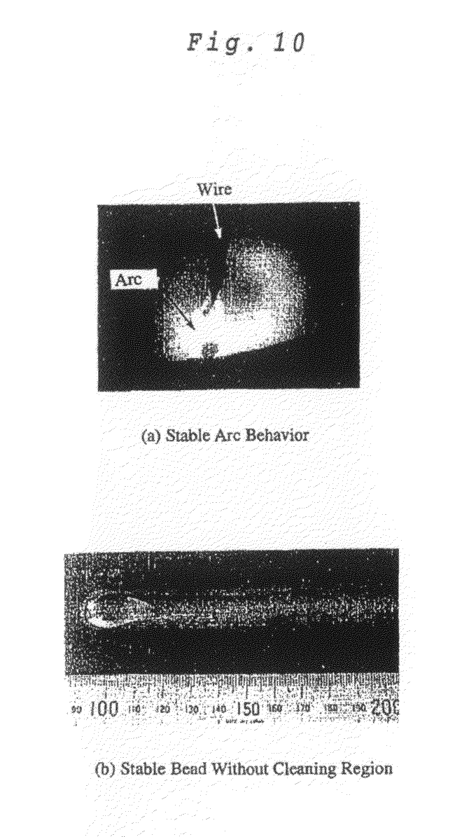

As shown in FIG. 9, a welding wire was fabricated in which the same potassium metal compound as in Example 1 was enclosed as an anode arc stabilizing element between the layers of a metal material containing a rare earth metal (REM) as a cathode stabilizing element. Arc welding was carried out in a pure argon gas using this welding wire. As shown in FIG. 9, in a droplet on the wire, an arc was concentrated because of the coexistence effect of potassium which is an anode arc stabilizing element even in a pure argon gas, whereby a stable droplet transfer was possible. In the weld pool, the cathode spot was concentrated because of a REM which is a cathode stabilizing element, so an arc did not unstably move around. Photographs of a welded site after arc welding are shown in FIG. 10. Because of a stable arc, a more stable bead without a cleaning region was obtained. The oxygen content of the welded site is 56 ppm, and it is confirmed that welding excellent in toughness is possible.

Moreover, in the examples, lamination was performed using a metal material produced by mixing a commercially available rare earth metal (REM) to fabricate a welding wire. However, a rare earth metal (REM) together with a potassium metal compound is enclosed between the layers of a metal material in which a rare earth metal (REM) is not mixed to thereby fabricate a welding wire. This welding wire is also expected to provide the same effect as that of the welding wire fabricated in the examples.

1. A welding wire, wherein
a plurality of metals are laminated so as to become a required composition without containing a flux, and
an alkaline metal compound is enclosed between the layers.

2. The welding wire of claim 1, wherein
the alkaline metal compound is a potassium metal compound.

3. The welding wire of claim 1, wherein
a rare earth metal compound is mixed into a metal material or potassium metal compound.

4. The welding wire of claim 1, wherein
the metal material is a different kind of a material.

5. A welding method using the welding wire of claim 1, wherein
the welding is carried out in an inert gas atmosphere containing an inert gas.

6. The welding method of claim 5, wherein
the concentration of the inert gas in the inert gas atmosphere is controlled to be above 95%.

7. The welding wire of claim 2, wherein
a rare earth metal compound is mixed into a metal material or potassium metal compound.

8. The welding wire of claim 2, wherein
the metal material is a different kind of a material.

9. The welding wire of claim 3, wherein
the metal material is a different kind of a material.

10. A welding method using the welding wire of claim 2, wherein
the welding is carried out in an inert gas atmosphere containing an inert gas.

11. A welding method using the welding wire of claim 3, wherein
the welding is carried out in an inert gas atmosphere containing an inert gas.

12. A welding method using the welding wire of claim 4, wherein
the welding is carried out in an inert gas atmosphere containing an inert gas.

13. The welding wire of claim 7, wherein
the metal material is a different kind of a material.

14. A welding method using the welding wire of claim 7, wherein
the welding is carried out in an inert gas atmosphere containing an inert gas.

15. A welding method using the welding wire of claim 8, wherein
the welding is carried out in an inert gas atmosphere containing an inert gas.

16. A welding method using the welding wire of claim 9, wherein
the welding is carried out in an inert gas atmosphere containing an inert gas.

17. A welding method using the welding wire of claim 13, wherein
the welding is carried out in an inert gas atmosphere containing an inert gas.

18. The welding method of claim 10, wherein
the concentration of the inert gas in the inert gas atmosphere is controlled to be above 95%.

19. The welding method of claim 11, wherein
the concentration of the inert gas in the inert gas atmosphere is controlled to be above 95%.

20. The welding method of claim 12, wherein
the concentration of the inert gas in the inert gas atmosphere is controlled to be above 95%.
